(19) United States
(12) Patent Application Publication
(10) Pub. No.: US 2013/0045146 A1
(43) Pub. Date: Feb. 21, 2013

(54) PROTECTIVE BARRIER AGAINST CONTAMINATION FROM SAMPLE PREPARATION AND EXTRACTION DEVICES

(71) Applicants: Tracey A. Peters, Lewistown, PA (US); Neil Mosesman, Mount Joy, PA (US); Jack Cochran, State College, PA (US); Jason D. Thomas, Boalsburg, PA (US); Julie Kowalski, Bellefonte, PA (US); Corby Hilliard, Blanchard, PA (US)

(72) Inventors: Tracey A. Peters, Lewistown, PA (US); Neil Mosesman, Mount Joy, PA (US); Jack Cochran, State College, PA (US); Jason D. Thomas, Boalsburg, PA (US); Julie Kowalski, Bellefonte, PA (US); Corby Hilliard, Blanchard, PA (US)

(21) Appl. No.: 13/464,389

(22) Filed: May 4, 2012

Related U.S. Application Data
(60) Provisional application No. 61/518,356, filed on May 4, 2011.

(51) Int. Cl. B01L 3/00; B01D 15/08

(52) U.S. Cl. 422/527; 422/547

(57) ABSTRACT

A plastic device, such as a syringe barrel, tube, cartridge, filter disk, tubing, solvent reservoir, connector, valve, frit, or container, for transferring or storing solids and liquids used in sample preparation and extraction (SPE) methods, is provided with a barrier coating layer of Parylene over the surface of the plastic device, to prevent contamination of the solids and liquids being transferred or stored by the inventive plastic device from contaminants introduced from the plastic of the device.

### CROSS REFERENCE TO RELATED APPLICATION

This application is based on and claims priority and benefit under 35 U.S.C. §119(e) of U.S. Provisional Application Ser. No. 61/518,356, which was filed on May 4, 2011 and which is incorporated herein by reference.

### BACKGROUND

Sample Preparation and Extraction (SPE)

SPE (sometimes also called ‘Solid Phase Extraction’) is a method of sample preparation employing solid sorbents that concentrates and purifies analytes from solution. The technique is well established [1-3] and employs the processes of liquid containment, liquid transfer, chemical sample purification (sorbent-based extraction), and bulk sample purification (filtration).

SPE as a technique generally involves passing the liquid sample across or through a solid sorbent. The function of the sorbent is either to:

(1) retain matrix compounds and allow the purified liquid sample to pass through, or

(2) retain the analytes of interest from the liquid sample; the analytes are then released from the adsorbent in a second step using an appropriate solvent.

In both cases the liquid sample is in physical contact with the inner cavity of the SPE sample handling assembly (i.e., the sample flow path).

Common sorbent materials used in SPE include inorganic media such as activated carbon (or graphitized carbon black), sodium sulfate (NaSO₄), and magnesium sulfate (MgSO₄), silicate-based media such as silica gel, Florisil® (MgO₃Si), and Diatomaceous Earth, various ion-exchange media such as Amberlite® XAD, or chemically functionalized media, such as primary-secondary amine (PSA), and octadecyl terminal groups (C18). The sorbents may be fashioned into amorphous powders, granules, spherical particles, or bulk porous solid structures such as cylinders, frits, and membranes.

Plastic containers are ubiquitous in the present-day laboratory for inexpensive, rugged, and disposable means to handle solids and liquids. SPE sample handling assemblies are increasingly made of disposable plastic housings and accessories in place of reusable glass elements. Housings for the sorbent material include syringe barrels, cartridges, and disks [1-3]. The technique also generally employs other various liquid handling elements such as tubing, solvent reservoirs, connectors (e.g., Luer connectors), valves, frits, and containers.

Modern SPE devices are desirably made of polypropylene, polyethylene, polyethylene terephthalate, polyethylene naphthalate, or copolymers thereof. These materials often contain plasticizers that assist in maintaining mechanical flexibility of the plastic part. Some common phthalate plasticizers are Bis(2-ethylhexyl) phthalate (DEHP), Diisononyl phthalate (DINP), Bis(n-butyl)phthalate (DnBP, DBP), Butyl benzyl phthalate (BBzP), Diisodecyl phthalate (DIDP), Di-n-octyl phthalate (DOP or DnOP), Diisooctyl phthalate (DIOP), Diethyl phthalate (DEP), Diisobutyl phthalate (DIBP), and Di-n-hexyl phthalate. Any of these plasticizers may be present in the plastics used to manufacture modern SPE devices.

In addition to phthalates, other plasticizers and sources of contamination may be trapped in the plastic. Examples include unreacted or partially reacted monomers, or any residual solvents used in the plastic manufacture or molding of the plastic part. These examples may also leach from the plastic into the solvents commonly employed for SPE applications.

Solvents commonly used in SPE extraction methods [1-7] include acetonitrile, methylene chloride, hexane, acetone, ethyl acetate, methanol, water, or mixtures thereof. In most cases phthalates from the plastic containers readily leach out of the plastic and dissolve into the sample solution. Many standard EPA sample extraction methods cite the antagonistic nature of phthalate contamination in environmental samples [4-7]. If plastic SPE devices are to be used, the EPA methods specify extensive cleaning and rinsing processes and recommend immediate use of the devices as a means to reduce phthalate contamination.

With the continued development of more sophisticated MS detectors the overall sensitivity of the analyses employing SPE is increasing. This results in an ever increasing need for contaminant-free SPE devices. As the sensitivity of the analysis increases the standard rinsing practices recommended in the methods become insufficient. Preferably the plastic elements should provide a stable environment for the sample solution during the SPE process.

In addition to contaminants originating from the plastic leaching directly into the SPE solvent, the sorbents employed in the SPE process are by definition also susceptible to contamination originating from the plastic. Over time, solid sorbent material may collect and concentrate contaminants, only then to release them into the liquid sample during the SPE process, increasing the likelihood that these contaminants will interfere with compounds of interest.

Beyond the transient contact of sample solutions with SPE cartridges, filters, and related connectors, prolonged contact of the purified sample with the collection vessel is often necessary. Here the risk of plasticizer leaching into the sample solution is much higher and glass is commonly still used for sample collection and storage. In some cases the transport and containment involve elevated temperature or elevated pressure or vacuum environments. This in turn can accelerate the leaching effect.

Parylene as an Organic Coating

“Parylene” is the generic name for members of the polymer series developed by Union Carbide Corporation. The base member of the series, called Parylene N, is poly-p-exlylene, a linear, crystalline material:

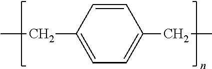

Parylene C, a second member of the Parylene series is produced from the same monomer as Parylene N and modified by the substitution of a chlorine atom for one other aromatic hydrogens:

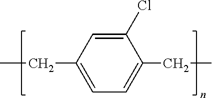

Parylene D, the third member of the Parylene series is produced from the same monomer as Parylene N and modified by the substitution of the chlorine atom for two of the aromatic hydrogens:

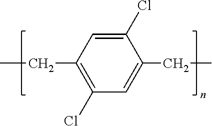

Parylene HF, the fourth member of the Parylene series is produced from the same monomer as Parylene N and modified by the substitution of the fluorine atom for two of the methylene hydrogens:

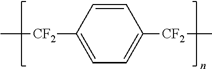

As indicated, Parylene (such as Parylene N) and Parylene derivative (including Parylene C, D, and HF) coatings applicable by vapor deposition are known for a variety of surface treatment uses, and are commercially available from or through a variety of sources, including Specialty Coating Systems™. (100 Deposition Drive, Clear Lake, Wis. 54005), Para Tech Coating, Inc. (35 Argonaut, Aliso Viejo, Calif. 92656) and Advanced Surface Technology, Inc. (9 Linnet Circle, Billerica, Mass. 01821-3902).

Parylene has been demonstrated to be an effective coating on a variety of surfaces to prevent chemical damage (e.g., corrosion) and physical damage (e.g., mechanical abrasion and scratching) of the underlying surface. Prior art using parylene coatings as barriers has focused on protecting the underlying solid surface from attack by the outside environment.

Plastic Containers with Barrier Coatings to Prevent Contamination from Outside the Container through the Container Wall

Plastic containers have been used for a multitude of sample storage applications. For some applications the plastic itself is insufficient to ensure long term stability of the inner container environment. Containers made from polypropylene have been shown to be permeable to gases and water vapor originating from outside the container.

In Tropsha et al. in U.S. Pat. No. 5,545,375 describes a blood tube where the mechanism for blood collection includes a vacuum resident in the tube, whereby the vacuum facilitates the collection of the blood sample. In this case, empty (i.e., unused) blood collection tubes must maintain the vacuum for up to 2 years. The blood tube includes a 2-layer barrier coating; the first layer closest to the plastic tube being a primer organic layer and a second metal oxide layer over the primer layer. In this invention the organic layer serves to improve the bonding of the metal oxide layer onto the blood tube, and the metal oxide layer serves to prevent gases and water vapor from transporting through the container wall from the outside environment and into the container cavity. In this invention a multilayer barrier is required as no single layer is sufficient and each layer serves a different role in the final device.

In later U.S. Patents such as U.S. Pat. Nos. 5,654,054, 5,683,771, and 5,716,683 Tropsha et al. include a topcoat parylene layer to serve primarily as physical protection of the metal oxide layer, as the metal oxide layer is prone to abrasive scratches or other means of mechanical removal. In this invention a multilayer barrier is required as no single layer is sufficient. In this case each individual layer of the multilayer serves a different role. The inorganic layers containing metal or silicon-based oxides serve the primary vapor barrier function. The organic layers serve primarily to:

(1) Enhance the adhesion of the metal oxide or silicon-bases layer to the underlying layer,

(2) Act as a second line of defense whereby the organic layer fills in any pinholes present from incomplete coverage of the inorganic layer, or

(3) Act as physical protection to prevent abrasion or scratching of the multilayer.

In the U.S. Pat. Nos. 5,736,207 and 5,763.033 it was demonstrated that even one multilayer is insufficient and more than one multilayered barrier was in fact necessary for long term containment of the vacuum; that repeat inorganic and organic layers were necessary to prevent gas contamination from traversing through the container wall from the outside environment as any single layer (or unique multilayer) was insufficient.

Plastic Containers with Barriers to Prevent Sample-Surface Interactions

Another example mechanism disclosed for barrier coatings on plastic containers relates to chemical interaction of the sample of interest and the uppermost surface of the container wall. In U.S. Patents such as U.S. Pat. Nos. 5,545,375, 5,654,054, 5,683,771, and 5,716,683 Tropsha et al. describe the ability of the multilayer barrier to reduce surface reactions between the container wall and the sample, as in the case of the container being a haemorepellant. In U.S. Pat. No. 6,290,655 the surface interaction is based on the hydrophilicity of the surface, where the intent is to enable easier flow of blood down the tube wall during collection.

Plastic Containers with Barriers to Prevent Leaching from the Plastic into the Sample

A third mechanism for sample contamination that has not been described in the prior art is the basis for this invention. When using plastic devices for SPE applications the solid sorbents and liquid sample solutions may be adversely impacted by contaminants originating from the plastic itself. The contaminants leach out of the plastic and into the solid sorbents and liquid sample solutions upon contact with the plastic device.

This source of contamination is not limited to the final container the prepared sample is delivered. Contaminants from inside the plastic are present along the entire path the sample traverses. This sample path includes any plastic device employed in the SPE process including syringe barrels, cartridges, tubes, filter disks, tubing, solvent reservoirs, connectors (e.g., Luer connectors), valves, frits, and containers.

While multilayer coated tubes would presumably be effective against this contamination mechanism, the presence of metal, metalloid, or oxides thereof are unnecessary. The costs related to creating multilayer containers is unnecessarily high, and the cost increase with increased number of multilayers. The transparency of the plastic container also decreases with increased number of layers or multilayers, and a single thin organic layer is preferred.

### DESCRIPTION OF THE INVENTION

We present an improved plastic device useful for the transfer and storage of solid SPE sorbents and liquid sample solutions, where the sample solutions are free from contaminants originating from within the plastic device. The plastic devices include the underlying plastic device coated with a single layer of parylene. Parylene has been demonstrated to be a sufficient barrier without the need for additional organic or inorganic layers, where the contaminants of interest originate from within the underlying plastic device.

Solid sorbents and liquid solvents and sample solutions have been demonstrated to be adequately protected from contaminants originating from the underlying plastic device under standard conditions described in SPE analytical methods.

The SPE devices are desirably made of polypropylene, polyethylene, polyethylene terephthalate, polyethylene naphthalate, or copolymers thereof.

Preferably the coating is chemically inert and immune to attack or dissolution from contact with the extraction solvents and resulting sample solutions.

Preferably Parylene is used for the coating and more preferably Parylene C is used to coat the plastic SPE devices.

Preferably the coating is less than 20 microns thick and more preferably less than 5 microns thick.

A preferred method for coating parylene onto target surfaces consists of three distinct steps [8]. The first step is vaporization of the solid dimer at approximately 150° C. The second step is the pyrolysis or cracking of the dimer at the two methylene-methylene bonds at about 680° C. to yield the stable monomeric diradical, para-xylylene. The third step the monomer enters the room temperature deposition chamber where it simultaneously adsorbs and polymerizes onto the substrate.

### DESCRIPTION OF FIGURES

FIG. 1. Figure of a standard vacuum manifold assembly employed for parallel processing of SPE samples. Figure taken from U.S. Pat. No. 4,810,471.

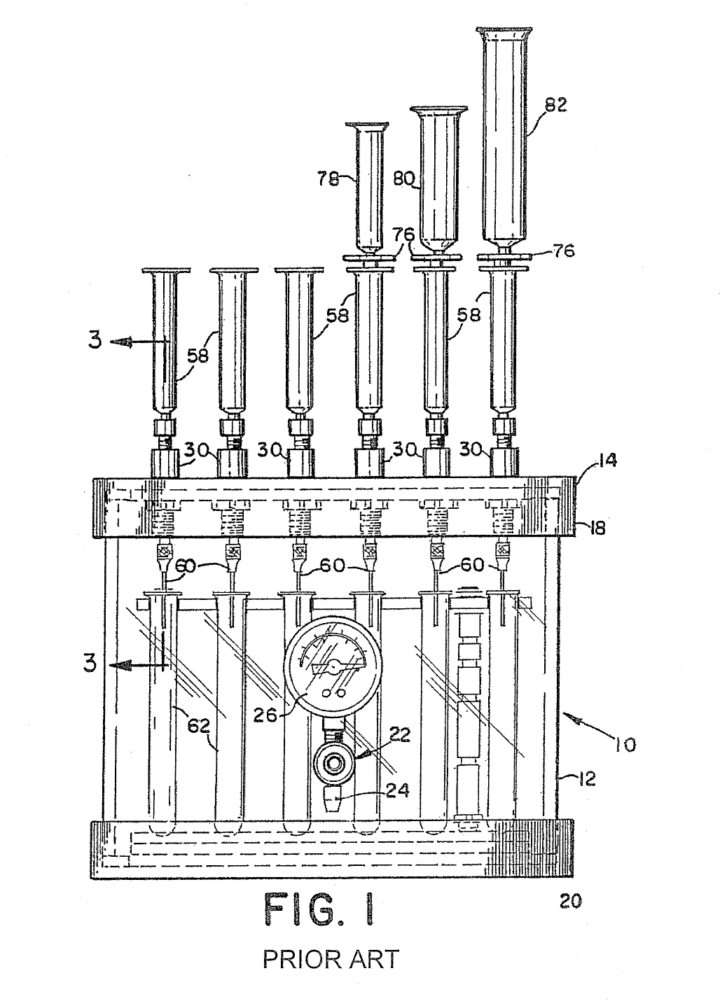

FIG. 2. Exploded cutaway view of a common SPE assembly showing the individual plastic devices.

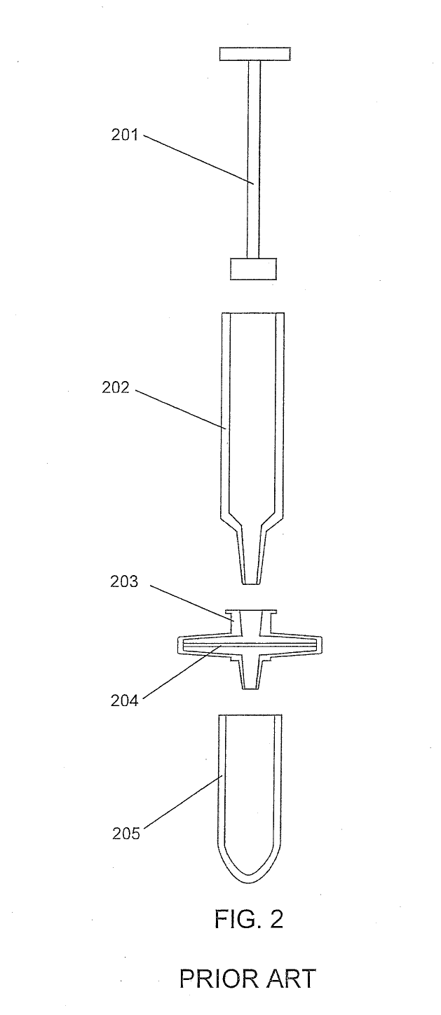

FIG. 3. Assembled cutaway view of a common SPE assembly showing the liquid sample path through the plastic devices.

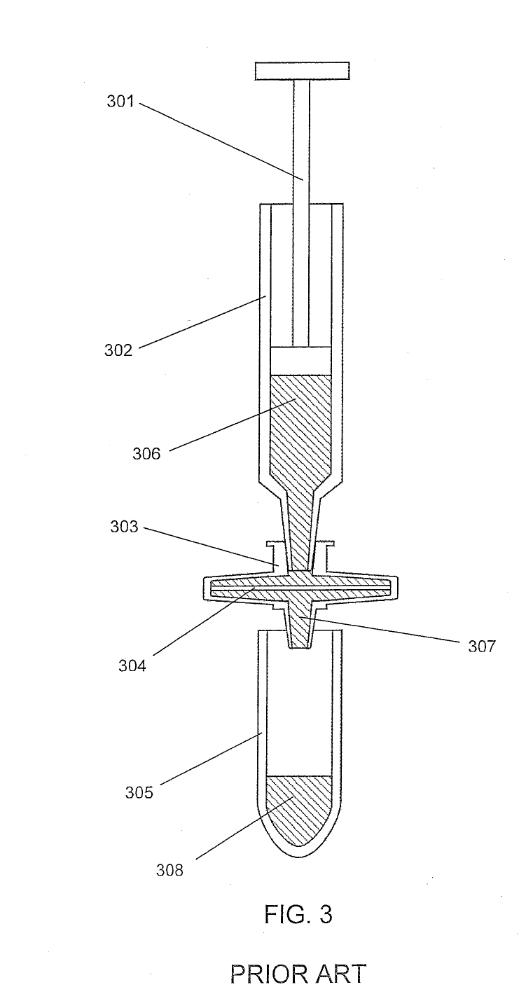

FIG. 4. Exploded cutaway view of a common SPE assembly showing the individual plastic devices, and assembled cutaway view of a common SPE assembly showing the liquid sample path through the plastic devices.

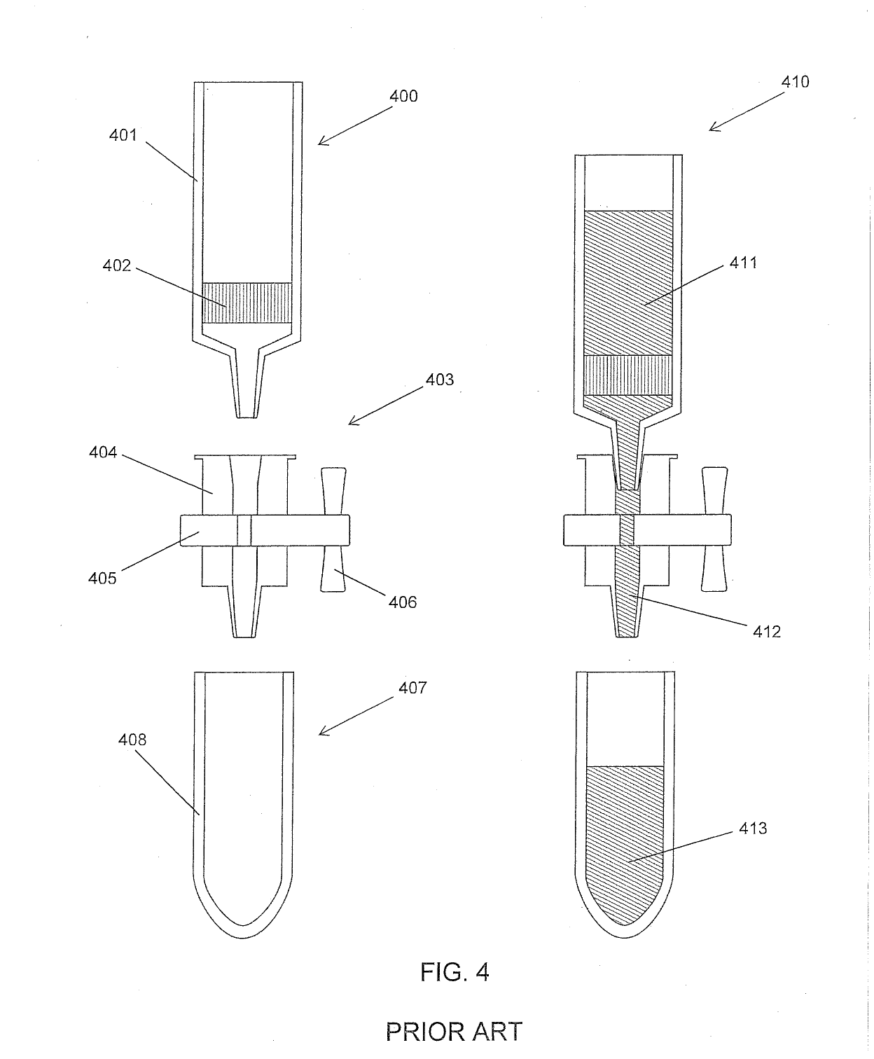

FIG. 5. Plastic tube assembly having a multilayer for preventing gas and vapor transport through the container from the outside. Figure taken from U.S. Pat. No. 5,716,683.

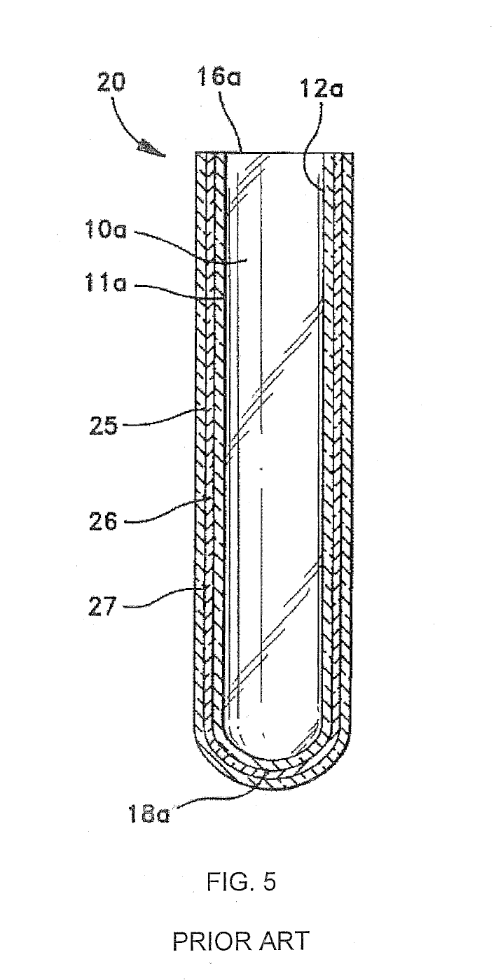

FIG. 6. Illustrations of sealed plastic containers showing the different mechanisms of sample contamination; (6a) illustrates transfer of contaminants from outside the container, through the wall of the container, and into the container (6b) illustrates sample-surface interactions inside the container, (6c) illustrates contamination of the sample where the contaminants originate from the plastic itself and leech into the sample upon direct contact with the plastic device.

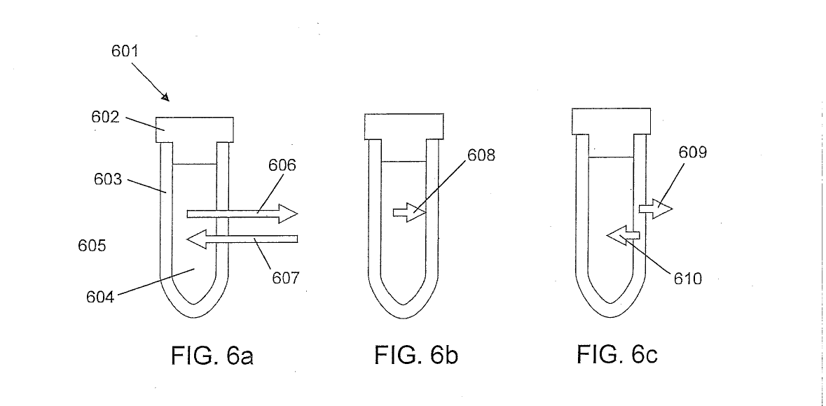

FIG. 7. Exploded cutaway view of a common SPE assembly showing the individual plastic devices wherein the devices have been coated with a protective Parylene layer.

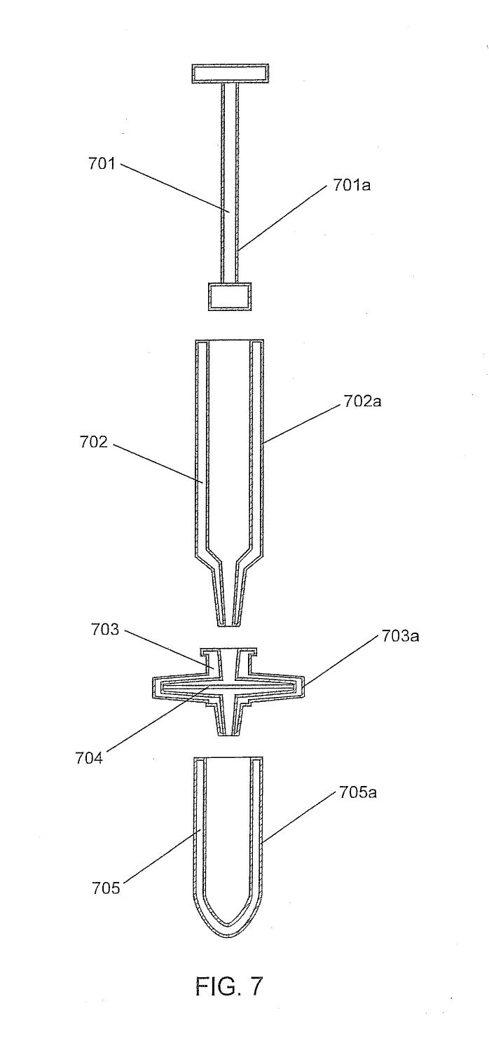

FIG. 8. Exploded cutaway view of a common SPE assembly showing the individual plastic devices wherein the devices have been coated with a protective Parylene layer, and assembled cutaway view of a common SPE assembly showing the liquid sample path through the plastic devices wherein the devices have been coated with a protective Parylene layer.

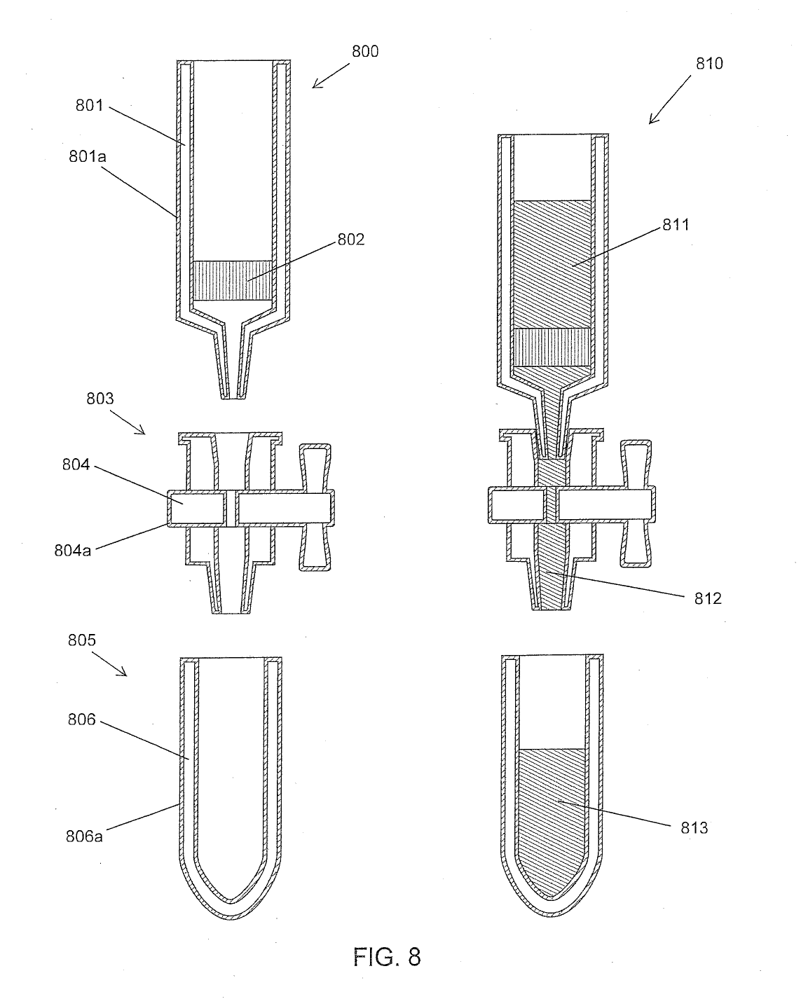

FIG. 9. Mass spectrometry data is shown solid primary secondary amine (PSA) sorbent where the sorbent was stored in (TOP) a clean amber glass jar and (BOTTOM) a commercially available plastic container (Qorpak) and then separately used in the QuEChERS SPE method. The data are blank runs of the PSA, i.e., no sample was included in the QuEChERS SPE extraction and any signal observed originates from contamination of the PSA from the container.

FIG. 10. Mass spectrometry data showing the effect of an accelerated lifetime experiment on PSA contamination. The top spectrograph represents PSA stored for 1 year at room temperature. The bottom spectrograph represents PSA stored for 1 hour at 100° C. In both cases the data are blank runs of the PSA, i.e., no sample was included in the QuEChERS SPE extraction and any signal observed originates from contamination of the PSA from the plastic container.

FIG. 11. Comparison data for PSA sorbent stored for 1 hour at 100° C. in (TOP) SPE container coated with Parylene C and (BOTTOM) standard uncoated SPE containers. The absence of signal in the top spectrograph indicates Parylene is an effective barrier for contamination originating from the plastic container.

### EXPERIMENTAL: AN SPE APPLICATION EMPLOYING PLASTIC ELEMENTS: QUECHERS

The QuEChERS method, which stands for quick, easy, cheap, effective, rugged, and safe (pronounced “catchers”) is an extraction method with a SPE cleanup based on research by the US Department of Agriculture Eastern Regional Research Center in Wyndmoor, Pa. [9,10]. The standard analytical methods employing QuEChERS are susceptible to the same phthalate contamination as those described in many analytical methods validated by government agencies [4-7].

Common sorbents used in the QuEChERS methods include primary-secondary amine (PSA), graphitized carbon black (GCB), C18, and magnesium sulfate (MgSO₄). Acetonitrile is the preferred solvent.

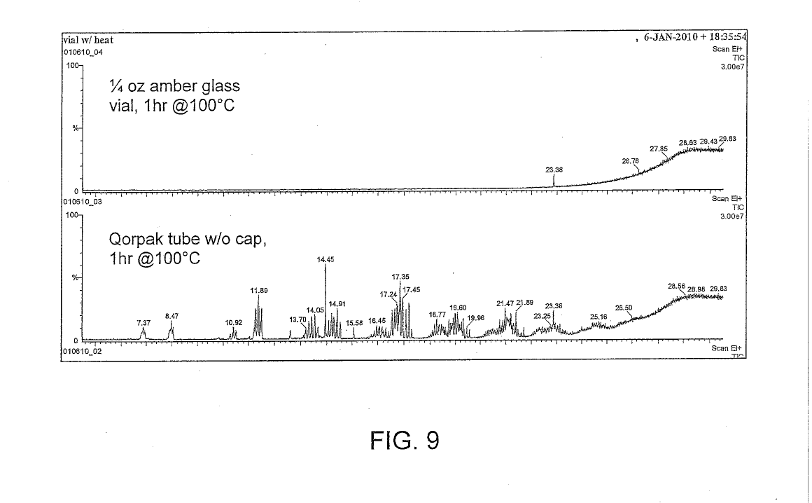

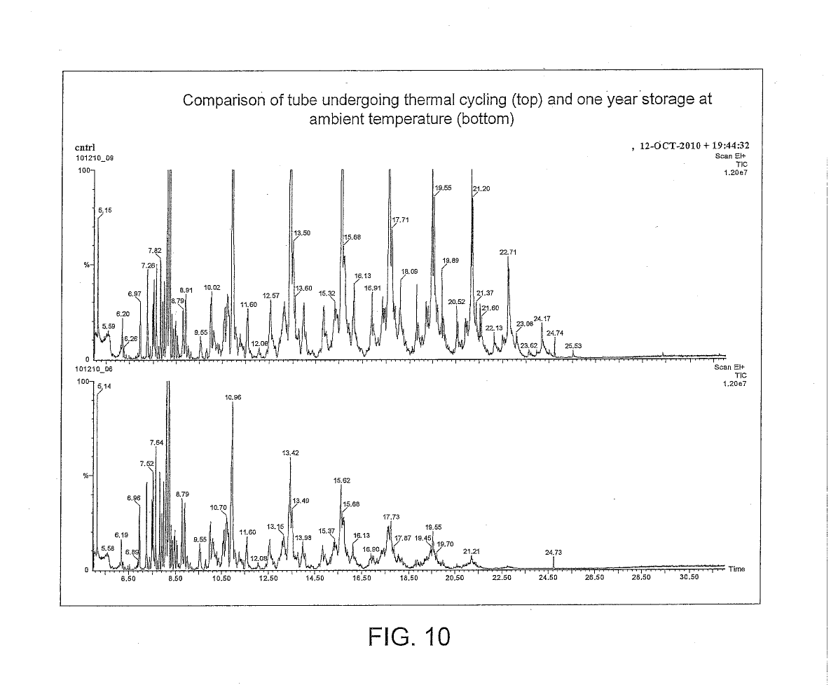

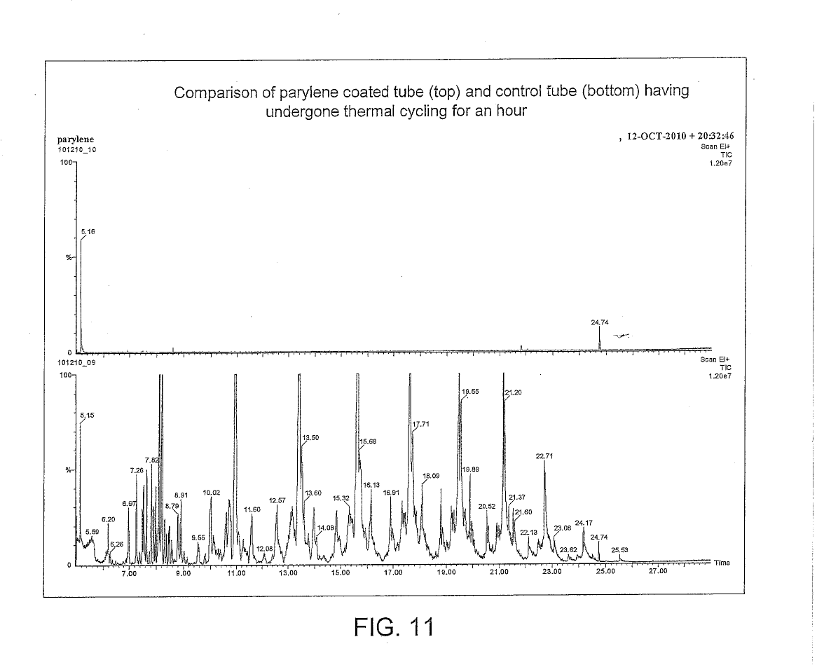

Polypropylene centrifuge tubes purchased from a number of different vendors were evaluated both with and without Parylene C coatings with the intent of providing a barrier between the effusing material of the polypropylene tube walls and the sorbent material inside the tube. Evaluation data is provided in FIGS. 9-11.

Samples of PSA were stored in commercially available centrifuge tubes at room temperature for up to 1 year. Samples were also stored in commercially available centrifuge tubes at 100° C. for 1 hour. PSA stored in clean ¼ oz. glass vials were used as controls. Following storage, the PSA was employed in blank-run SPE methods employing the QuEChERS protocol. Blank solvent extractions were then analyzed on a gas chromatograph with a mass spectrometry detector (GC/MS).

In order to determine whether the Parylene coating would exhibit some solvent incompatibility, an empty tube was first sent through the extraction procedure as described below. No visual signs of the coating being dissolved in the solvent were evident and the stability tests were conducted.

Conclusions:

The data provided indicates the Parylene coated tubes do not cause contamination in PSA stored in the tube, by creating an impenetrable barrier to the migrating entities originating from the polypropylene. This also suggests that the Parylene itself is not leaching out undesired material into the stored PSA. The evaluation of the tubes stored for one year showed that all contained high levels of contamination and although they each had their characteristic profile and intensity, they were all approximately equally undesirable.

Experimental Procedure:

An accelerated stability test was performed on a second Parylene coated tube, along with an un-coated control tube, as follows: 150 mg of PSA was added to the tube and placed in a GC oven at 100° C. for 1 hour. After the tube cooled, 7 mL of ACN was added and 7 μL of a 1000 ppm solution of triphenylphosphate was spiked followed by hand shaking for one minute. The tubes were then centrifuged for 5 minutes in the Q-sep 3000, an aliquot of the supernatant pulled off for analysis using a PerkinElmer Clarus 500 GC/MS equipped with a programmable split/splitless injector (PSSI), and autosampler as follows. An Rxi-17Sil MS capillary column, 20 m×0.18 mm×0.14 μm, was used for the analysis.

The archived 15 mL tubes had been each filled with 150 mg of PSA and included two different part #'s from Allpak, one from BD Falcon, and two different model numbers from Globe Scientific. They were stored under ambient conditions for approximately one year. These tubes were extracted and analyzed as described above.

Instrument Conditions:

Oven program: 40° C.→310° C. (5 min.) @10° C./min

Injection temperature: 250° C.; Injection volume: 1.0 μL

Carrier: Helium, constant flow @1.0 mLs/min.

Injection mode: Splitless, purge flow: 50 mLs/min. @1.5 minutes

Detector Interface: 300° C.; Source Temp: 280° C.; Scan Range; 45-450 amu

The patents and references referred to in this application and listed below are hereby incorporated herein by reference.

U.S. Patent Documents

| | | |
|---|---|---|
| 4,131,200 | Rinfret | Thermoplastic blood bag |
| D289,861 | Wachob, et al. | Extraction vacuum manifold |
| 4,810,471 | Wachob, et al. | Vacuum manifold for extraction |
| | | processing |
| 5,545,375 | Tropsha, et al. | Blood collection tube assembly |
| 5,654,054 | Tropsha, et al. | Barrier coating |
| 5,665,280 | Tropsha | Blood collection tube assembly |
| 5,683,771 | Tropsha | Blood collection tube assembly |
| 5,686,157 | Harvey, et al. | Blood collection tube assembly |
| 5,716,683 | Harvey, et al. | Blood collection tube assembly |
| 5,736,207 | Walther, et al. | Vessel of plastic having a barrier coating |
| | | and a method of producing the vessel |
| 5,738,920 | Knors | Blood collection tube assembly |
| 5,763,033 | Tropsha, et al. | Blood collection tube assembly |
| 5,900,285 | Walther, et al. | Method of making a vessel having a wall |
| | | surface having a barrier coating |
| 5,919,328 | Tropsha, et al. | Blood collection tube assembly |
| 5,952,069 | Tropsha, et al. | Blood collection tube assembly |
| 5,955,161 | Tropsha | Blood collection tube assembly |
| 5,968,620 | Harvey, et al. | Blood collection tube assembly |
| 6,013,337 | Knors | Blood collection tube assembly |
| 6,054,188 | Tropsha, et al. | Non-ideal barrier coating architecture and |
| | | process for applying the same |
| | | to plastic substrates |
| 6,165,566 | Tropsha | Method for depositing a multilayer barrier |
| | | coating on a plastic substrate |
| 6,180,191 | Felts | Method for plasma deposition of a thin |
| | | film onto a surface of a container |
| 6,290,655 | Serpentino, et al. | Blood collection assembly |
| 6,586,063 | Albanesi, et al. | Multiple layer container |
| 6,631,743 | Enders, et al. | Flexible cord-like hollow object |
| 6,749,078 | Iskra | Collection assembly |
| 6,807,989 | Enders, et al. | Flexible cord-like hollow object |

### REFERENCES

[1] Thurman, E. M.; Mills, M. S.; “Solid Phase Extraction, Principles and Practice”; 1998; John Wiley & Sons, Inc.

[2] Fritz, J. S.; “Analytical Solid-Phase Extraction”; 1999; John Wiley & Sons, Inc.

[3] Simpson, N J. K., Wells, M. J. M.; “Solid Phase Extraction, Principles, Techniques, and Applications”; 2000; Marcel Dekker, Inc.

[4] United States Environmental Protection Agency Method 515.2; “Determination of chlorinated acids in water using liquid-solid extraction and gas chromatography with an electron capture detector”; Revision 1.0; August 1992.

[⁵] United States Environmental Protection Agency Method 528-1; “Determination of phenols in drinking water by solid phase extraction and capillary column gas chromatography/mass spectrometry (GC/MS)”; Revision 1.0; April 2000.

[6] United States Environmental Protection Agency Method 522-1; “Determination of 1,4-dioxane in drinking water by solid phase extraction (SPE) and gas chromatography/mass spectrometry (GC/MS) with selected ion monitoring (SIM)”; Version 1.0; September, 2008; EPA/600/R-08/101.

[7] Brumley, W. C.; Shaffer, E. M.; and Tillander, P. E.; “Determination of Phthalates in Water and Soil by Tandem Mass Spectrometry Under Chemical Ionization Conditions with Isobutane as Reagent Gas”; Intern. J. Off. Anal. Chem. 77, 1230-1236 (1970).

[8] Wolgemuth, L.; Kumar, R.; “Advances in Conformal Coatings: Enhancing Reliability of Innovative Technologies”; Tech Briefs Media Group webinar; Oct. 27, 2009.

[9] Anastassiades, M.; Lehotay, S. J.; \check{S}tajnbaher, D.; Schenck, F. J. “Fast and Easy Multiresidue Method Employing Acetonitrile Extraction/Partitioning and Dispersive Solid-Phase Extraction for the Determination of Pesticide Residues in Produce”, J. AOAC International, 2003, vol. 86(22), pp. 412-431.

[10] AOAC Official Method 2007.01, Pesticide Residues in Foods by Acetonitrile Extraction and Partitioning with Magnesium Sulfate.

We claim:

1. A plastic device for transfer of solids and liquids used in sample preparation and extraction (SPE) methods, wherein the device prevents contamination originating from the plastic device, the device comprising:
a. A sample flow path predominantly made of plastic, and
b. A layer of Parylene coated over the surfaces defining the flow path.

2. The device of claim 1 where the plastic is polypropylene, polyethylene, polyethylene terephthalate, polyethylene naphthalate, or copolymers thereof.

3. The device of claim 1 where the Parylene coating is less than 20 microns thick.

4. The device of claim 1 where the Parylene coating is Parylene C.

5. The device of claim 1 where the plastic device includes a porous frit.

6. The device of claim 1 where the plastic device includes a porous membrane.

7. The device of claim 1 where the plastic device includes a solid sorbent.

8. The device of claim 7 where the sorbent contains graphitized carbon black.

9. The device of claim 7 where the sorbent contains primary-secondary amine.

10. The device of claim 7 where the sorbent contains Amberlite® XAD.

11. The device of claim 7 where the sorbent contains at least one of the inorganic sorbents magnesium sulfate (MgSO₄), (MgO₃Si), (NaSO₄), or Diatomaceous Earth.

12. The device of claim 7 where the sorbent contains functionalized polymeric divinylbenzene.

13. A plastic device for storage of solids and liquids used in sample preparation and extraction (SPE) methods, wherein the device prevents contamination originating from the plastic device. The device comprises:
a. A sample container predominantly made of plastic, and
b. A layer of Parylene coated over the surfaces of the sample container.

14. The device of claim 13 where the Parylene coating is less than 20 microns thick.

15. The device of claim 13 where the Parylene coating is Parylene C.
